(19) United States
(12) Patent Application Publication
(10) Pub. No.: US 2026/0317470 A1
(43) Pub. Date: Oct. 15, 2026

(54) TERTIARY AMINE CATALYST FOR POLYURETHANE FOAM

(71) Applicant: HUNTSMAN PETROCHEMICAL LLC, The Woodlands, TX (US)

(72) Inventors: Renjie JI, Shanghai (CN); Yide LIANG, Shanghai (CN); Min WU, Shanghai (CN)

(21) Appl. No.: 19/108,250

(22) PCT Filed: Sep. 6, 2023
(86) PCT No.: PCT/US2023/032052

§ 371 Date: Mar. 3, 2025

Related U.S. Application Data
(60) Provisional application No. 63/403,932, filed on Sep. 6, 2022.

(51) Int. Cl. C08G 18/20

(52) U.S. Cl. CPC C08G 18/2027; C08G 2110/0008; C08G 2110/0025

(57) ABSTRACT

Piperazine-based tertiary amine catalysts for use in a polyurethane formulation. The polyurethane formulation includes the piperazine-based tertiary amine catalyst, a compound containing an isocyanate functional group, an active hydrogen-containing compound and optionally one or more of a blowing agent and additive.

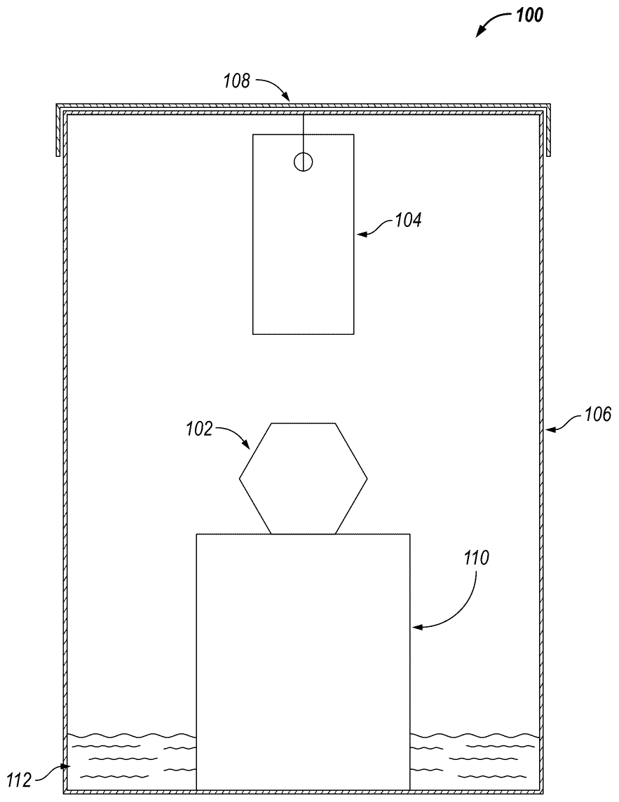

### CROSS-REFERENCE TO RELATED APPLICATION

This application claims priority to U.S. Provisional Application 63/403,932 filed Sep. 6, 2022. The noted application(s) are incorporated herein by reference.

### STATEMENT REGARDING FEDERALLY SPONSORED RESEARCH OR DEVELOPMENT

Not applicable.

### FIELD

The present disclosure generally relates to a tertiary amine catalyst for use in the production of flexible foam and other polyurethane materials.

### BACKGROUND

Polyurethane foams are widely known and used in a variety of applications, such as in the automotive and housing industry. These foams are produced by the reaction of a polyisocyanate with a polyol in the presence of various additives. One such additive is an amine catalyst which is used to accelerate blowing (the reaction of water with polyisocyanate to generate CO₂) and gelling (the reaction of the polyol with polyisocyanate).

Disadvantages in using conventional amine catalysts (for example, triethylenediamine, bisdimethylaminoethylether) in polyurethane foam production include the occurrence of safety and toxicity problems due to their high volatility and resulting airborne vapors. Various attempts have been made to reduce such emissions by attaching functional groups on the amine catalyst or increasing its molecular weight. However, polyurethane foams produced using these improved catalysts still emit vapors due to thermal and/or hydrolytic instability of the covalent bonds between the amine catalyst and polyurethane polymer. It is therefore desirable to improve on the performance of known amine catalysts that have been commonly used in the art in the production of polyurethane foam.

### SUMMARY

The present disclosure provides a polyurethane formulation comprising a piperazine-based tertiary amine catalyst, a compound containing an isocyanate functional group and an active hydrogen-containing compound.

According to another embodiment, there is provided a catalyst package for use in forming a polyurethane material comprising the piperazine-based tertiary amine catalyst and a second component selected from an amine catalyst containing at least one tertiary amine group, a non-amine catalyst, a halogenated olefin compound and a mixture thereof.

In yet another embodiment, there is provided a method of forming a polyurethane material comprising contacting a compound containing an isocyanate functional group, an active hydrogen-containing compound and optionally one or more of a blowing agent and additive(s) in the presence of the piperazine-based tertiary amine catalyst.

### BRIEF DESCRIPTION OF THE DRAWINGS

The FIGURE depicts the apparatus used in the polycarbonate staining test of Example 1.

### DETAILED DESCRIPTION

The following terms shall have the following meanings:

The term “comprising” and derivatives thereof are not intended to exclude the presence of any additional component, step or procedure, whether or not the same is disclosed herein. In order to avoid any doubt, all compositions claimed herein through use of the term “comprising” may include any additional additive or compound, unless stated to the contrary. In contrast, the term, “consisting essentially of” if appearing herein, excludes from the scope of any succeeding recitation any other component, step or procedure, except those that are not essential to operability and the term “consisting of”, if used, excludes any component, step or procedure not specifically delineated or listed. The term “or”, unless stated otherwise, refers to the listed members individually as well as in any combination.

The articles “a” and “an” are used herein to refer to one or to more than one (i.e. to at least one) of the grammatical objects of the article. By way of example, “a catalyst” means one catalyst or more than one catalyst. The phrases “in one embodiment”, “according to one embodiment” and the like generally mean the particular feature, structure, or characteristic following the phrase is included in at least one embodiment of the present disclosure, and may be included in more than one embodiment of the present disclosure. Importantly, such phrases do not necessarily refer to the same aspect. If the specification states a component or feature “may”, “can”, “could”, or “might” be included or have a characteristic, that particular component or feature is not required to be included or have the characteristic.

The term “about” as used herein can allow for a degree of variability in a value or range, for example, it may be within 10%, within 5%, or within 1% of a stated value or of a stated limit of a range.

Values expressed in a range format should be interpreted in a flexible manner to include not only the numerical values explicitly recited as the limits of the range, but to also include all of the individual numerical values or sub-ranges encompassed within that range as if each numerical value and sub-range is explicitly recited. For example, a range such as from 1 to 6, should be considered to have specifically disclosed sub-ranges, such as, from 1 to 3, from 2 to 4, from 3 to 6, etc., as well as individual numbers within that range, for example, 1, 2, 3, 4, 5, and 6. This applies regardless of the breadth of the range.

The terms “preferred” and “preferably” refer to embodiments that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the present disclosure.

The term “substantially free” refers to a composition in which a particular compound or moiety is present in an amount that has no material effect on the composition. In some embodiments, “substantially free” may refer to a composition in which the particular compound or moiety is present in the composition in an amount of less than 2% by weight, or less than 1% by weight, or less than 0.5% by weight, or less than 0.1% by weight, or less than 0.05% by weight, or even less than 0.01% by weight based on the total weight of the composition, or that no amount of that particular compound or moiety is present in the respective composition.

Where substituent groups are specified by their conventional chemical formula, written from left to right, they equally encompass the chemically identical substituents that would result from writing the structure from right to left, for example, —CH₂O— is equivalent to —OCH₂—.

The term “alkyl” refers to straight chain or branched chain saturated hydrocarbon groups having from 1 to 10 carbon atoms. In some embodiments, alkyl substituents may be lower alkyl groups. The term “lower” refers to alkyl groups having from 1 to 5 carbon atoms. Examples of “lower alkyl groups” include, but are not limited to, methyl, ethyl, n-propyl, i-propyl, and butyl groups.

The term “halogenated olefin” refers to an olefin compound or moiety which may include fluorine, chlorine, bromine or iodine.

The term “optional” or “optionally” means that the subsequently described event or circumstance may or may not occur, and that the description includes instances where said event or circumstance occurs and instances where it does not.

The present disclosure is generally directed to a piperazine-based tertiary amine catalyst and its use in polyurethane formulations which may include a compound containing an isocyanate functional group, an active hydrogen-containing compound and optionally one or more of a blowing agent and additive(s). The present disclosure is also directed to a catalyst package for use in forming a polyurethane material including the piperazine-based tertiary amine catalyst and a second component selected from an amine catalyst containing at least one tertiary amine group, a non-amine catalyst, a halogenated olefin compound, and a mixture thereof. The present disclosure is further directed to rigid or flexible polyurethane foam or other polyurethane material made from a formulation comprising the piperazine-based tertiary amine catalyst as described herein, a compound containing an isocyanate functional group, an active hydrogen-containing compound and optionally one or more of a blowing agent and additive(s). The term “polyurethane” as used herein, is understood to encompass pure polyurethane, polyurethane polyurea, and pure polyurea. It has been surprisingly found when the piperazine-based tertiary amine catalyst of the present disclosure is used in the production of polyurethane foam, the amine catalyst is capable of forming highly stable covalent bonds within the polyurethane matrix so that the polyurethane foam exhibits low (or is substantially free of) amine emission. Because of this stability, should the polyurethane foam come into contact with a surface of another material (such as polycarbonate) at high temperatures and/or high humidity conditions, the material will not be damaged or stained.

According to one embodiment, the piperazine-based tertiary amine catalyst is a compound represented by formula (1)

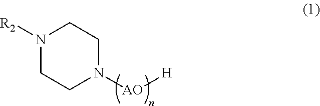

where n is an integer from 0 to about 25; AO is an alkyl oxide independently selected in each AO unit from —C₂H₄O—, —C₃H₆O— and —C₄H₈O—; and R₂ is methyl, ethyl, isopropyl or —R₃R₄—X where R₃ and R₄ are independently selected from methyl, ethyl, and an isopropyl amino group and X is a lower alkyl group optionally interrupted by an oxygen atom. In one embodiment, n is an integer less than about 20 or less than about 15 or less than about 10 or less than about 5. In another embodiment, n is an integer of at least about 2 or at least about 5 or at least about 10. In still another embodiment, n is an integer from about 1 to about 15 or from about 2 to about 10 or from about 3 to about 8 or from about 4 to about 6.

In another embodiment, AO in the piperazine-based tertiary amine catalyst of formula (1) is independently selected in each AO unit from —C₂H₄O— and —C₃H₆O—. In still another embodiment, AO in each AO unit is —C₃H₆O— while in another embodiment, AO in each AO unit is —C₂H₄O—. In still another embodiment, R₂ in the piperazine-based tertiary amine catalyst of formula (1) is methyl or ethyl.

According to some embodiments, the piperazine-based tertiary amine catalyst of formula (1) may be used alone in forming the polyurethane foam or material. In still other embodiments, the piperazine-based tertiary amine catalyst may be combined with an amine catalyst containing at least one tertiary amine group or a non-amine catalyst or a mixture thereof in forming the polyurethane foam or material. In embodiments in which the piperazine-based tertiary amine catalyst of formula (1) is combined with an amine catalyst containing at least one tertiary amine group, or a non-amine catalyst, or a mixture thereof the weight ratio of the piperazine-based tertiary amine catalyst of formula (1) to the amine catalyst containing at least one amine group, or the non-amine catalyst or mixture thereof is at least 1:1, and in some embodiments, at least 1.5:1 and in still other embodiments at least 2:1 and in further embodiments at least 5:1, while in still further embodiments at least 10:1. In still other embodiments, the weight ratio of the piperazine-based tertiary amine of formula (1) to the amine catalyst containing at least one amine group, or the non-amine catalyst or mixture thereof is from 0.1:99.9 to 99.9:0.1, and in still other embodiments from 1:99 to 99:1, and in still other embodiments from 5:95 to 95:5, and in further embodiments from 10:90 to 90:10, while in still further embodiments from 25:75 to 75:25.

Representative amine catalysts containing at least one tertiary group include, but are not limited to, bis-(2-dimethylaminoethyl) ether (commercially available as JEFFCAT® ZF-20 catalyst), N,N,N′-trimethyl-N′-hydroxyethylbisaminoethylether (commercially available as JEFFCAT® ZF-10 catalyst), N-(3-dimethylaminopropyl)-N,N-diisopropanolamine (commercially available as JEFFCAT® DPA catalyst), N,N-dimethylethanolamine (commercially available as JEFFCAT® DMEA catalyst), triethylene diamine (commercially available as JEFFCAT® TEDA catalyst), blends of N,N-dimethylethanolamine ethylene diamine (including those commercially available as JEFFCAT® TD-20 catalyst), N,N-dimethylcyclohexylamine (commercially available as JEFFCAT® DMCHA catalyst), benzyldimethylamine (commercially available as JEFFCAT® BDMA catalyst), pentamethyldiethylenetriamine (commercially available as JEFFCAT® PMDETA catalyst), N,N,N′,N″,N″-pentamethyldipropylenetriamine (commercially available as JEFFCAT® ZR-40 catalyst), N,N-bis(3-dimethylaminopropyl)-N-isopropanolamine (commercially available as JEFFCAT® ZR-50 catalyst), N′-(3-(dimethylamino) propyl-N,N-dimethyl-1,3-propanediamine (commercially available as JEFFCAT® Z-130 catalyst), 2-(2-dimethylaminoethoxy) ethanol (commercially available as JEFFCAT® ZR-70 catalyst), N,N,N-trimethylaminoethyl-ethanolamine (commercially available as JEFFCAT® Z-110 catalyst), N-ethylmorpholine (commercially available as JEFFCAT® NEM catalyst), N-methylmorpholine (commercially available as JEFFCAT® NMM catalyst), 4-methoxyethylmorpholine, N,N′dimethylpiperazine (commercially available as JEFFCAT® DMP catalyst), 2,2′-dimorpholinodiethylether (commercially available as JEFFCAT® DMDEE catalyst), 1,3,5-tris(3-(dimethylamino) propyl)-hexahydro-s-triazine (commercially available as JEFFCAT® TR-90 catalyst), 1-propanamine, 3-(2-(dimethylamino) ethoxy), substituted imidazoles such as 1,2-dimethlyimidazol and 1-methyl-2-hydroxyethylimidazole, bis-substituted piperazines such aminoethylpiperazine, N,N′,N′-trimethyl aminoethylpiperazine or bis-(N-methyl piperazine) urea, N-methylpyrrolidines and substituted methylpyrrolidines such as 2-aminoethyl-N-methylpyrrolidine or bis-(N-methylpyrrolidine)ethyl urea, 3-dimethylaminopropylamine, N,N,N″,N″-tetramethyldipropylenetriamine, tetramethylguanidine, 1,2-bis-diisopropanol. Other examples of amine catalysts include N-alkylmorpholines, such as N-butylmorpholine and dimorpholinodiethylether, N,N′-dimethylaminoethanol, N,N-dimethylamino ethoxyethanol, bis-(dimethylaminopropyl)-amino-2-propanol, bis-(dimethylamino)-2-propanol, bis-(N,N-dimethylamino)ethylether; N,N,N′-trimethyl-N′hydroxyethyl-bis-(aminoethyl) ether, N,N-dimethyl amino ethyl-N′-methyl amino ethanol, 1-[2-(Dimethylamino)ethyl]piperazine and tetramethyliminobispropylamine. The aforementioned JEFFCAT® catalysts are available from Huntsman Petrochemical LLC, The Woodlands, Texas.

Other amine catalysts which may be used in the present disclosure may be found in Appendix D in “Dow Polyurethanes Flexible Foams” by Herrington et al. at pages D.1-D.23 (1997), which is incorporated herein by reference. Further examples may be found in “JEFFCAT® Amine Catalysts for the Polyurethane Industry” version JCT-0910 which is incorporated herein by reference.

The non-amine catalyst is a compound (or mixture thereof) having catalytic activity for the reaction of an isocyanate group with a polyol or water, but is not a compound falling within the description of the amine catalysts above. Examples of such additional non-amine catalysts include, for example: tertiary phosphines, such as trialkylphosphines and dialkylbenzylphosphines; chelates of various metals, such as those which can be obtained from acetylacetone, benzoylacetone, trifluoroacetyl acetone, ethyl acetoacetate and the like, with metals such as Be, Mg, Zn, Cd, Pd, Ti, Zr, Sn, As, Bi, Cr, Mo, Mn, Fe, Co and Ni; metal carboxylates such as potassium acetate and sodium acetate; acidic metal salts of strong acids, such as ferric chloride, stannic chloride, stannous chloride, antimony trichloride, bismuth nitrate and bismuth chloride; strong bases, such as alkali and alkaline earth metal hydroxides, alkoxides and phenoxides; alcoholates and phenolates of various metals, such as Ti(OR⁶)₄, Sn(OR⁶)₄ and Al(OR⁶)₃ where R⁶ is alkyl or aryl, and the reaction products of the alcoholates with carboxylic acids, beta-diketones and 2-(N,N-dialkylamino) alcohols; alkaline earth metal, Bi, Pb, Sn, or Al carboxylate salts; and tetravalent tin compounds, and tri- or pentavalent bismuth, antimony, or arsenic compounds.

The piperazine-based tertiary amine catalyst of formula (1) may be used in a catalytically effective amount to catalyze the reaction between a compound containing an isocyanate functional group and an active hydrogen-containing compound for making rigid or flexible polyurethane foam or other polyurethane materials. A catalytically effective amount of the piperazine-based tertiary amine catalyst of formula (1) may range from about 0.01-15 parts per 100 parts of active hydrogen-containing compound, and in some embodiments from about 0.05-12.5 parts per 100 parts of active hydrogen-containing compound, and in even further embodiments from about 0.1-7.5 parts per 100 parts of active hydrogen-containing compound, and yet in even further embodiments from about 0.5-5 parts per 100 parts of active hydrogen-containing compound.

In one embodiment, the compound containing an isocyanate functional group is a polyisocyanate, an isocyanate-terminated prepolymer, or a mixture thereof.

Polyisocyanates include those represented by the general formula Q (NCO) a where a is a number from 2-5, such as 2-3 and Q is an aliphatic hydrocarbon group containing 2-18 carbon atoms, a cycloaliphatic hydrocarbon group containing 5-10 carbon atoms, an araliphatic hydrocarbon group containing 8-13 carbon atoms, or an aromatic hydrocarbon group containing 6-15 carbon atoms.

Examples of polyisocyanates include, but are not limited to, ethylene diisocyanate; 1,4-tetramethylene diisocyanate; 1,6-hexamethylene diisocyanate; 1,12-dodecane diisocyanate; cyclobutane-1,3-diisocyanate; cyclohexane-1,3- and 1,4-diisocyanate, and mixtures of these isomers; isophorone diisocyanate; 2,4- and 2,6-hexahydrotoluene diisocyanate and mixtures of these isomers; dicyclohexylmethane-4,4′-diisocyanate (hydrogenated MDI, or HMDI); 1,3- and 1,4-phenylene diisocyanate; 2,4- and 2,6-toluene diisocyanate and mixtures of these isomers (TDI); diphenylmethane-2,4′- and/or -4,4′-diisocyanate (MDI); naphthylene-1,5-diisocyanate; triphenylmethane-4,4′,4″-triisocyanate; polyphenyl-polymethylene-polyisocyanates of the type which may be obtained by condensing aniline with formaldehyde, followed by phosgenation (crude MDI); norbornane diisocyanates; m- and p-isocyanatophenyl sulfonylisocyanates; perchlorinated aryl polyisocyanates; modified polyisocyanates containing carbodiimide groups, urethane groups, allophnate groups, isocyanurate groups, urea groups, or biruret groups; polyisocyanates obtained by telomerization reactions; polyisocyanates containing ester groups; and polyisocyanates containing polymeric fatty acid groups. Those skilled in the art will recognize that it is also possible to use mixtures of the polyisocyanates described above.

Isocyanate-terminated prepolymers may also be employed in the preparation of the polyurethane. Isocyanate-terminated prepolymers may be prepared by reacting an excess of polyisocyanate or mixture thereof with a minor amount of an active-hydrogen containing compound as determined by the well-known Zerewitinoff test.

In another embodiment, the active hydrogen-containing compound is a polyol. Polyols suitable for use in the present disclosure include, but are not limited to, polyalkylene ether polyols, polyester polyols, polymer polyols, a non-flammable polyol such as a phosphorus-containing polyol or a halogen-containing polyol. Such polyols may be used alone or in suitable combination as a mixture.

Polyalkylene ether polyols include poly(alkylene oxide) polymers such as poly(ethylene oxide) and poly(propylene oxide) polymers and copolymers with terminal hydroxyl groups derived from polyhydric compounds, including diols and triols; for example, ethylene glycol, propylene glycol, 1,3-butane diol, 1,4-butane diol, 1,6-hexane diol, neopentyl glycol, diethylene glycol, dipropylene glycol, pentaerythritol, glycerol, diglycerol, trimethylol propane, and similar low molecular weight polyols.

Polyester polyols include, but are not limited to, those produced by reacting a dicarboxylic acid with an excess of a diol, for example, adipic acid with ethylene glycol or butanediol, or reaction of a lactone with an excess of a diol such as caprolactone with propylene glycol.

In addition to polyalkylene ether polyols and polyester polyols, polymer polyols are also suitable for use in the present disclosure. Polymer polyols are used in polyurethane materials to increase resistance to deformation, for example, to improve the load-bearing properties of the foam or material. Examples of polymer polyols include, but are not limited to, graft polyols or polyurea modified polyols (Polyharnstoff Dispersion polyols). Graft polyols comprise a triol in which vinyl monomers are graft copolymerized. Suitable vinyl monomers include, for example, styrene, or acrylonitrile. A polyurea modified polyol is a polyol containing a polyurea dispersion formed by the reaction of a diamine and a diisocyanate in the presence of a polyol. A variant of polyurea modified polyols are polyisocyanate poly addition (PIPA) polyols, which are formed by the in situ reaction of an isocyanate and an alkanolamine in a polyol.

The non-flammable polyol may, for example, be a phosphorus-containing polyol obtainable by adding an alkylene oxide to a phosphoric acid compound. A halogen-containing polyol may, for example, be those obtainable by ring-opening polymerization of epichlorohydrin or trichlorobutylene oxide.

The polyurethane formulation may also contain one or more blowing agents. In one embodiment, a halogenated olefin compound serves as the blowing agent. The halogenated olefin compound comprises at least one haloalkene (e.g, fluoroalkene or chlorofluoroalkene) comprising from 3 to 4 carbon atoms and at least one carbon-carbon double bond. Suitable compounds may include hydrohaloolefins such as trifluoropropenes, tetrafluoropropenes (e.g., tetrafluoropropene (1234)), pentafluoropropenes (e.g., pentafluoropropene (1225)), chlorotrifluoropropenes (e.g., chlorotrifluoropropene (1233)), chlorodifluoropropenes, chlorotrifluoropropenes, chlorotetrafluoropropenes, hexafluorobutenes (e.g., hexafluorobutene (1336)), or combinations thereof. In certain embodiments, the tetrafluoropropene, pentafluoropropene, and/or chlorotrifluoropropene compounds have no more than one fluorine or chlorine substituent connected to the terminal carbon atom of the unsaturated carbon chain (e.g., 1,3,3,3-tetrafluoropropene (1234ze); 1,1,3,3-tetrafluoropropene, 1,2,3,3,3-pentafluoropropene (1225ye), 1,1,1-trifluoropropene, 1,2,3,3,3-pentafluoropropene, 1,1,1,3,3-pentafluoropropene (1225zc), 1,1,2,3,3-pentafluoropropene (1225yc), (Z)-1,1,1,2,3-pentafluoropropene (1225yez), 1-chloro-3,3,3-trifluoropropene (1233zd), 1,1,1,4,4,4-hexafluorobut-2-ene (1336mzzm), or combinations thereof).

Other blowing agents that may be used alone or in combination with the halogenated olefin compounds described above include air, nitrogen, carbon dioxide, hydrofluorocarbons (“HFCs”), alkanes, alkenes, mono-carboxylic acid salts, ketones, ethers, or combinations thereof. Suitable HFCs include 1,1-difluoroethane (HFC-152a), 1, 1,1,2-tetrafluoroethane (HFC-134a), pentafluoroethane (HFC-125), 1,1,1,3,3-pentafluoropropane (HFC-245fa), 1,1,1,3,3-pentafluorobutane (HFC-365mfc), or combinations thereof. Suitable alkanes and alkenes include n-butane, n-pentane, isopentane, cyclopentane, 1-pentene, or combinations thereof. Suitable mono-carboxylic acid salts include methyl formate, ethyl formate, methyl acetate, or combinations thereof. Suitable ketones and ethers include acetone, dimethyl ether, or combinations thereof.

In addition, the polyurethane formulation may optionally include one or more additives. Examples of additives include, but are not limited to, crosslinking agents, cell stabilizers, surfactants, chain extenders, pigments, fillers, flame retardants, thermally expandable microspheres, water, thickening agents, smoke suppressants, reinforcements, antioxidants, UV stabilizers, antistatic agents, infrared radiation absorbers, dyes, mold release agents, antifungal agents, biocides, or any combination thereof. In some embodiments, the amine catalyst containing at least one tertiary group and non-amine catalyst described above may also be considered additives.

Crosslinking agents may include, for example, polyhydric alcohols (especially trihydric alcohols, such as glycerol and trimethylolpropane), polyamines, and combinations thereof. Non-limiting examples of polyamine crosslinking agents include diethyltoluenediamine, chlorodiaminobenzene, diethanolamine, diisopropanolamine, triethanolamine, tripropanolamine, 1,6-hexanediamine, and combinations thereof. Typical diamine crosslinking agents comprise twelve carbon atoms or fewer, more commonly seven or fewer.

Cell stabilizers may include, for example, silicon surfactants or anionic surfactants. Examples of suitable silicon surfactants include, but are not limited to, polyalkylsiloxane, polyoxyalkylene polyol-modified dimethylpolysiloxane, alkylene glycol-modified dimethylpolysiloxane, or any combination thereof.

Suitable surfactants (or surface-active agents) include emulsifiers and foam stabilizers, such as silicone surfactants known in the art, for example, polysiloxanes, as well as various amine salts of fatty acids, such as diethylamine oleate or diethanolamine stearate, as well as sodium salts of ricinoleic acids.

Examples of chain extenders include, but are not limited to, compounds having hydroxyl or amino functional groups, such as glycols, amines, diols, and water. Further non-limiting examples of chain extenders include ethylene glycol, propylene glycol, 1,4-butanediol, 1,3-butanediol, 1,5-pentanediol, 1,6-hexanediol, 1,10-decanediol, 1,12-dodecanediol, ethoxylated hydroquinone, 1,4-cyclohexanediol, N-methylethanolamine, N-methylisopropanolamine, 4-aminocyclo-hexanol, 1,2-diaminoethane, or any mixture thereof.

Pigments may be used to color code the polyurethane materials during manufacture, to identify product grade, or to conceal yellowing. Pigments may include any suitable organic or inorganic pigments. For example, organic pigments or colorants include, but are not limited to, azo/diazo dyes, phthalocyanines, dioxazines, or carbon black. Examples of inorganic pigments include, but are not limited to, titanium dioxide, iron oxides, or chromium oxide.

Fillers may be used to increase the density and load bearing properties of polyurethane foam or material. Suitable fillers include, but are not limited to, barium sulfate, carbon black, or calcium carbonate.

Flame retardants can be used to reduce flammability. For example, such flame retardants include, but are not limited to, chlorinated phosphate esters, chlorinated paraffins, or melamine powders.

Thermally expandable microspheres include those containing a (cyclo) aliphatic hydrocarbon. Such microspheres are generally dry, unexpanded or partially unexpanded microspheres consisting of small spherical particles with an average diameter of typically 10 to 15 micron. The sphere is formed of a gas proof polymeric shell (e.g., consisting of acrylonitrile or PVDC), encapsulating a minute drop of a (cyclo) aliphatic hydrocarbon, e.g., liquid isobutane. When these microspheres are subjected to heat at an elevated temperature level (e.g., 150° C. to 200° C.) sufficient to soften the thermoplastic shell and to volatilize the (cyclo) aliphatic hydrocarbon encapsulated therein, the resultant gas expands the shell and increases the volume of the microspheres. When expanded, the microspheres have a diameter 3.5 to 4 times their original diameter as a consequence of which their expanded volume is about 50 to 60 times greater than their initial volume in the unexpanded state. Examples of such microspheres are the EXPANCEL®-DU microspheres which are marketed by AKZO Nobel Industries of Sweden.

The methods for generally producing a polyurethane material from a polyurethane formulation are described in, for example, U.S. Pat. Nos. 5,420,170, 5,648,447, 6,107,359, 6,552,100, 6,737,471 and 6,790,872, the contents of which are hereby incorporated by reference. Various types of polyurethane materials can be made using the piperazine-based tertiary amine catalyst, such as rigid foams, flexible foams, semi-flexible foams, microcellular elastomers, backings for textiles, spray elastomers, cast elastomers, polyurethane-isocyanurate foams, reaction injection molded polymers, structural reaction injection molded polymers and the like.

A non-limiting example of a general flexible polyurethane foam formulation having a 15-150 kg/m³ density (e.g., automotive seating) containing the piperazine-based tertiary amine catalyst of formula (1) may comprise the following components in parts by weight (pbw):

| Flexible Foam Formulation | pbw |
|---|---|
| Polyol | 20-100 |
| Surfactant | 0.3-3 |
| Blowing Agent | 1-6 |
| Crosslinker | 0-3 |
| Piperazine-based catalyst | 0.2-2.5 |
| Isocyanate Index | 70-115 |

A non-limiting example of a general rigid polyurethane foam formulation having a 15-70 kg/m³ density containing the piperazine-based tertiary amine of formula (1) may comprise the following components in parts by weight (pbw):

| Rigid Foam Formulation | Pbw |
|---|---|
| Polyol | 100 |
| Surfactant | 1-3 |
| Blowing Agent | 20-40 |
| Water | 0-3 |
| Piperazine-based catalyst | 0.5-3 |
| Isocyanate Index | 80-400 |

The amount of the compound containing an isocyanate functional group is not limited, but will generally be within those ranges known to one skilled in the art. An exemplary range given above is indicated by reference to Isocyanate Index which is defined as the number of equivalents of isocyanate divided by the total number of equivalents of active hydrogen, multiplied by 100.

Thus, in yet another embodiment, the present disclosure provides a method for producing a polyurethane material which comprises contacting the compound containing an isocyanate functional group, an active hydrogen-containing compound, optionally one or more of a blowing agent and additive(s) in the presence of the piperazine-based tertiary amine catalyst according to the present disclosure.

In one particular embodiment, the polyurethane material is a rigid or flexible foam prepared by bringing together at least one compound containing an isocyanate functional group and at least one active hydrogen-containing compound, such as a polyisocyanate and polyol, in the presence of the piperazine-based tertiary amine catalyst of formula (1) and optionally one or more of a blowing agent and additive(s) to form a reaction mixture and subjecting the reaction mixture to conditions sufficient to cause the polyol to react with the polyisocyanate. The polyisocyanate, polyol, piperazine-based tertiary amine catalyst and optional blowing agent/additive(s) may be heated prior to mixing them and forming the reaction mixture. In other embodiments, the polyisocyanate, polyol, piperazine-based tertiary amine catalyst and optional blowing agent/additive(s) are mixed at ambient temperature (for e.g., from about 15° C.-40° C.) and heat may be applied to the reaction mixture, but in some embodiments, applying heat may not be necessary. The polyurethane foam may be made in a free rise (slabstock) process in which the foam is free to rise under minimal or no vertical constraints. Alternatively, molded foam may be made by introducing the reaction mixture in a closed mold and allowing it to foam within the mold. The particular polyisocyanate and polyol are selected with the desired characteristics of the resulting foam. Other additives useful in making polyurethane foams, such as those described above, may also be included to produce a particular type of foam.

According to another embodiment, a polyurethane material may be produced in a one-step process in which an A-side reactant is reacted with a B-side reactant. The A-side reactant may comprise a polyisocyanate while the B-side reactant may comprise a polyol, the piperazine-based tertiary amine catalyst and optional blowing agent. In some embodiments, the A-side and/or B-side may also optionally contain one or more additives described above.

The polyurethane materials may be used in a variety of applications, such as, a precoat; a backing material for carpet; building composites; insulation; spray foam insulation; applications requiring use of impingement mix spray guns; urethane/urea hybrid elastomers; vehicle interior and exterior parts such as bed liners, dashboards, door panels, and steering wheels; flexible foams (such as furniture foams and vehicle component foams); integral skin foams; rigid spray foams; rigid pour-in-place foams; coatings; adhesives; sealants; filament winding; and other polyurethane composite, foams, elastomers, resins, and reaction injection molding (RIM) applications.

The present disclosure will now be further described with reference to the following non-limiting examples.

### EXAMPLES

### Example 1. Polycarbonate Staining Test/Amine Emission

A polycarbonate (PC) staining test was performed using an apparatus 100 generally shown in the FIGURE. The apparatus 100 can include a container 106, such as a glass container, having a removable lid 108 which can house second, inverted container 110, such as an inverted glass container or aluminum bridge, that can support a polyurethane foam sample 102, such that the polyurethane foam sample 102 is maintained above water 112. A polycarbonate slab 104 can be suspended from the top of the container 106 such that a desired distance from the polyurethane foam sample 102 is maintained. For the purposes of Example 1, the polyurethane foam samples 102 were produced using the components described in Table 1:

TABLE 1

| Sample | | 1 | 2 | 3 | 4 | 5 | 6 | 7 |
|---|---|---|---|---|---|---|---|---|
| Polyol A¹ | pbw | 70 | 70 | 70 | 70 | 70 | 70 | 70 |
| Polyol B² | pbw | 30 | 30 | 30 | 30 | 30 | 30 | 30 |
| Diethanolamine | pbw | 1.0 | 1.0 | 1.0 | 1.0 | 1.0 | 1.0 | 1.0 |
| Foam Stabilizer | pbw | 0.7 | 0.7 | 0.7 | 0.7 | 0.7 | 0.7 | 0.7 |
| Amine | pbw | 0.2 | | | | | | |
| Catalyst³ | | | | | | | | |
| Amine | pbw | | 0.4 | | | | | |
| Catalyst⁴ | | | | | | | | |
| Amine | pbw | | | 0.4 | | | | |
| Catalyst⁵ | | | | | | | | |
| Amine | pbw | | | | 0.4 | | | |
| Catalyst⁶ | | | | | | | | |
| Amine | pbw | | | | | 1.0 | | |
| Catalyst⁷ | | | | | | | | |
| Amine | pbw | | | | | | 6.7 | |
| Catalyst⁸ | | | | | | | | |
| Amine | pbw | | | | | | | 4.7 |
| Catalyst⁹ | | | | | | | | |

¹Polyetherol with OH number 28 mgKOH/g
²Polyetherol with OH number 20 mgKOH/g
³2,2-dimorpholinodiethylether
⁴Dimethylpiperazine
⁵Triethylenediamine
⁶Dimethyl imidazole
⁷N-methylpiperazine with one mol propylene oxide according to the present disclosure
⁸N-methylpiperazine with 10 mol propylene oxide according to the present disclosure
⁹1,4-piperizinediethanol

The apparatus 100 was set up such that the distance between the polyurethane foam sample 102 and the polycarbonate slab (30 mm by 10 mm by ±3 mm) 104 was at a minimum of 2 cm. The apparatus 100 was then placed in an oven for 7 days and held at a temperatures of 90° C. After the first 24 hours, the polyurethane foam sample 102 was observed without opening the container 106 to determine color change/transparency. After 7 days, the polyurethane foam sample 102 was then removed from the container 106 and inspected for color change, transparency, cracks/splits/swelling and stickiness. In addition, amine emission from the polyurethane foam sample 102 was determined according to the VDA-28 Test Method as described in U.S. Pat. No. 11,101,757, the contents of which is incorporated herein by reference. The results are presented below in Table 2.

TABLE 2

| Sample | | 1 | 2 | 3 | 4 | 5 | 6 | 7 |
|---|---|---|---|---|---|---|---|---|
| PC staining test | | | | | | | | |
| 24 hrs | | Clear | Clear | Clear | Dew | Clear | Clear | Clear |
| @90° C./100% rel. | | | | | Drop | | | |
| humidity | | | | | | | | |
| observation of PC | | | | | | | | |
| strips | | | | | | | | |
| 7 days | | Slight | Clear | Corrosion | Staining, | Corrosion | Clear | Deep |
| @90° C./100% rel. | | hazy, | | of the | corrosion | of the | | corrosion |
| humidity | | yellow | | surface, | of the | surface, | | of the |
| observation of PC | | | | sticky | copper | sticky | | surface, |
| strips | | | | | wire | | | sticky |
| VDA-278 test | | | | | | | | |
| Amine emission | ppm | | 295 | 260 | | 290 | 5 | 5 |
| in VOC&Fog | | | | | | | | |
| emissions | | | | | | | | |

While the foregoing is directed to embodiments of the present disclosure, other and further embodiments of the disclosure may be devised without departing from the basic scope thereof, and the scope thereof is determined by the claims that follow.

What is claimed is:

1. A polyurethane formulation comprising: (i) a piperazine-based tertiary amine catalyst represented by formula (1) 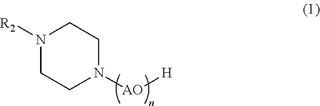
wherein n is an integer from 0 to about 25; AO is an alkyl oxide independently selected in each AO unit from —C₂H₄O—, —C₃H₆O— and —C₄H₈O—; and R₂ is methyl, ethyl, isopropyl, or —R₃R₄—X where R₃ and R₄ are independently selected from methyl, ethyl and an isopropyl amino group and X is a lower alkyl group optionally interrupted by an oxygen atom,
(ii) a compound containing an isocyanate functional group, and
(iii) an active hydrogen-containing compound.

2. The polyurethane formulation of claim 1, wherein n is an integer from about 2 to about 10.

3. The polyurethane formulation of claim 1, wherein AO is independently selected in each AO unit from —C₂H₄O—, and —C₃H₆O—.

4. The polyurethane formulation of claim 1, wherein AO in each AO unit is —C₃H₆O—.

5. The polyurethane formulation of claim 1, wherein the polyurethane formulation further comprises an amine catalyst containing at least one tertiary amine group, or a non-amine catalyst, or a mixture thereof.

6. The polyurethane formulation of claim 1, wherein the polyurethane formulation further comprises one or more of a blowing agent and additive.

7. A catalyst package for use in forming a polyurethane material comprising: (i) a piperazine-based tertiary amine catalyst represented by formula (1) 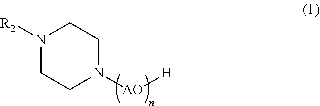
wherein n is an integer from 0 to about 25; AO is an alkyl oxide independently selected in each AO unit from —C₂H₄O—, —C₃H₆O— and —C₄H₈O—; and R₂ is methyl, ethyl, isopropyl, or —R₃R₄—X where R₃ and R₄ are independently selected from methyl, ethyl and an isopropyl amino group and X is a lower alkyl group optionally interrupted by an oxygen atom,
(ii) and a second component selected from an amine catalyst containing at least one tertiary amine group, a non-amine catalyst, a halogenated olefin compound and a mixture thereof.

8. The catalyst package of claim 7, wherein n is about 2 to about 10.

9. The catalyst package of claim 8, wherein AO in each AO unit is —C₃H₆O—.

10. A method for producing a polyurethane material comprising contacting a compound containing an isocyanate functional group, an active hydrogen-containing compound and optionally one or more of a blowing agent and additive in the presence of a piperazine-based tertiary amine represented by formula (1) 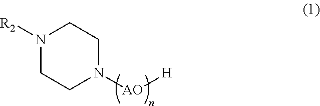
wherein n is an integer from 0 to about 25; AO is an alkyl oxide independently selected in each AO unit from —C₂H₄O—, —C₃H₆O— and —C₄H₈O—; and R₂ is methyl, ethyl, isopropyl, or —R₃R₄—X where R₃ and R₄ are independently selected from methyl, ethyl and an isopropyl amino group and X is a lower alkyl group optionally interrupted by an oxygen atom.

11. The method of claim 10, wherein n is an integer from about 2 to about 10 and R₂ is methyl.

12. A polyurethane material produced according to the method of claim 10.

13. The polyurethane material of claim 12, wherein the polyurethane material is a rigid foam or a flexible foam.

14. The polyurethane material produced according to the method of claim 12 for use as a precoat, a backing material for carpet, a building composite, insulation, a spray foam insulation, a urethane/urea hybrid elastomers; in vehicle interior and exterior parts, a flexible foam, an integral skin foam, a rigid spray foam, a rigid pour-in-place foam; a coating; an adhesive, a sealant, or a filament winding.
